(19) United States
(12) Patent Application Publication
(10) Pub. No.: US 2022/0163136 A1
(43) Pub. Date: May 26, 2022

(54) SYSTEM AND METHOD FOR MONITORING FLOW RATE OF REGULATING VALVE BASED ON ACOUSTIC SENSOR

(71) Applicant: HUANENG CLEAN ENERGY RESEARCH INSTITUTE, Beijing (CN)

(72) Inventors: Weidong LI, Beijing (CN); Baomin WANG, Beijing (CN); Yusen YANG, Beijing (CN)

(21) Appl. No.: 17/133,687

(22) Filed: Dec. 24, 2020

(30) Foreign Application Priority Data
Nov. 23, 2020 (CN) 202011325228.X

(51) Int. Cl. F16K 37/00; G01F 1/66

(52) U.S. Cl. CPC F16K 37/0066; G01F 1/666

(57) ABSTRACT

Disclosed is a system and method for monitoring flow rate of a regulating valve based on an acoustic sensor. The system includes: the regulating valve installed in a fluid pipeline, the regulating valve including an actuator and a valve body and being a regulating valve calibrated by an experimental platform; the acoustic sensor installed at the regulating valve and configured to collect an acoustic signal of the regulating valve and transmit the acoustic signal to a signal transmission apparatus; the signal transmission apparatus configured to receive the acoustic signal collected by the acoustic sensor and transmit the acoustic signal to an acoustic data analysis platform; and the acoustic data analysis platform configured to monitor flow rate of the regulating valve by receiving the acoustic signal transmitted by the signal transmission apparatus.

### CROSS-REFERENCE TO RELATED APPLICATIONS

The present application claims priority to Chinese Patent Application No. 202011325228.X, filed on Nov. 23, 2020, the content of which is incorporated herein by reference in its entirety.

### TECHNICAL FIELD

The present disclosure relates to the technical field of monitoring of regulating valves, and particularly relates to a system and method for monitoring flow rate of a regulating valve based on an acoustic sensor.

### BACKGROUND

Flow rate measurement is an important part of measurement science and technology. It has been widely applied to various fields such as industrial and agricultural production, environmental protection, scientific research, foreign trade, and life of people. The accurate and rapid flow rate measurement plays an important role in guaranteeing the product quality, increasing the economic benefit, saving the energy and promoting the development of science and technology. In the era of the increasingly prominent energy crisis, the status and role of the flow measurement become more and more important in the national economy. As one of key technologies in the industrial process, the flow rate measurement has always been widely concerned and deeply studied. Conventional flow meters include differential pressure flow meters, volumetric flow meters, rotor flow meters, electromagnetic flow meters, ultrasonic flow meters, Coriolis flow meters, etc., of which the differential pressure flow meters are researched extensively. The differential pressure flow meter is an instrument that measures the flow rate according to a differential pressure generated by flow detection elements installed in a pipeline, known fluid conditions and geometric dimensions of the detection element and the pipeline.

A regulating valve is an element with a variable resistance in a pipeline system. Operating characteristics of the pipeline system can be changed by changing the openness of the valve, thereby achieving a purpose of regulating the flow and changing the pressure. The regulating valve is an indispensable fluid control device in national economic departments such as petroleum, chemical industry, power stations, long distance pipelines, etc. Compared with other basic industrial equipment such as pumps, compressors, etc., the regulating valve is relatively simple in structure, thereby being often undervalued.

At present, the flow rate of the regulating valve is generally detected by the flow meter, but the conventional flow meter is high in price and may bring additional resistance and fault points to the pipeline system.

### SUMMARY

A purpose of the present disclosure is to provide a system and method for monitoring flow rate of a regulating valve based on an acoustic sensor so as to solve the technical problems of fluid pipelines caused by using a flow meter to measure the flow rate in the related art.

To achieve the above purpose, the present disclosure adopts the following technical solutions.

A system for monitoring the flow rate of a regulating valve based on an acoustic sensor includes:

the regulating valve installed in a fluid pipeline, the regulating valve including an actuator and a valve body and being a regulating valve calibrated by an experimental platform;

the acoustic sensor installed at the regulating valve and configured to collect an acoustic signal of the regulating valve and transmit the acoustic signal to a signal transmission apparatus;

the signal transmission apparatus used to receive the acoustic signal collected by the acoustic sensors and transmit the acoustic signal to an acoustic data analysis platform; and

the acoustic data analysis platform configured to monitor flow rate of the regulating valve by receiving the acoustic signal transmitted by the signal transmission apparatus.

A further improvement of the present disclosure is that the regulating valve is a pneumatic regulating valve, an electric regulating valve or a hydraulic regulating valve.

A further improvement of the present disclosure is that the regulating valve is one of a straightway single-seat valve, a straightway double-seat valve, a sleeve valve, a ball valve, a butterfly valve, an eccentric rotary valve, a linear valve, an equal-percentage valve, a parabolic valve, or a quick opening valve.

A further improvement of the present disclosure is that the acoustic sensor is any one or a combination of a listening apparatus, a pickup, a micro-displacement electric signal sound sensor, a surface acoustic sensor, a dynamic pressure sensor, an acoustic frequency sensor, an acoustic sound pressure sensor, an acoustic sound intensity sensor or an acoustic sound power sensor.

A further improvement of the present disclosure is that the surface acoustic sensor is any one or a combination of a Rayleigh wave sensor, an optical fiber sensor, a piezoelectric array sensor, a tangential horizontal plate-mold sensor, a Lamb wave sensor or a Love wave sensor.

A further improvement of the present disclosure is that the acoustic sensor is arranged inside the regulating valve, or is arranged outside the regulating valve and close to a valve core thereof.

A further improvement of the present disclosure is that the acoustic sensor has an ID code corresponding to a geographic information code of a geographic position of the acoustic sensor; and the geographic information code and model information of the regulating valve are attached in the collected acoustic signal for being transmitted by the acoustic sensor.

A further improvement of the present disclosure is that the acoustic data analysis platform further includes a display unit configured to display a position of the regulating valve and the corresponding acoustic signal.

A further improvement of the present disclosure is that the acoustic data analysis platform performs an analysis to obtain the flow rate of the regulating valve by:

calculating the flow rate of the regulating valve under a condition of a given upstream pressure by using a pre-fitted relational formula between the acoustic signal and the flow rate of the regulating valve of a model to be analyzed under an adjustment of the given upstream pressure.

A further improvement of the present disclosure is that the data analysis platform is loaded with a noise elimination algorithm.

A further improvement of the present disclosure is that the experimental platform includes a flow rate calibration pipeline. An inlet of the flow rate calibration pipeline is connected to an outlet of a water storage tank, and an outlet of the flow rate calibration pipeline is connected to an inlet of the water storage tank. A speed regulation variable-frequency circulating water pump and the regulating valve are installed in the flow rate calibration pipeline. A first pressure sensor is installed at an upstream of the regulating valve in the flow rate calibration pipeline, and a flow sensor is installed at a downstream of the regulating valve in the flow rate calibration pipeline. The acoustic sensor is provided on the regulating valve. Output ends of the flow sensor, the first pressure sensor and the acoustic sensor are connected to an input end of a data collector, and an output end of the data collector is connected to an input end of the acoustic data analysis platform. The data collector is used to transmit acoustic signals, flow rate signals and upstream pressure signals collected by the acoustic sensor, the flow sensor and the first pressure sensor to the data analysis platform. The data analysis platform is used to fit a relational expression between the flow rate and the acoustic signal of the regulating valve under different upstream pressures and openness of the regulating valve based on the received acoustic signal, the flow rate signal and the upstream pressure signal.

A method for monitoring the flow rate of a regulating valve based on an acoustic sensor includes the following steps: obtaining a corresponding fitting formula based on an upstream pressure of the regulating valve of a monitored model in a practical detection process, and calculating the flow rate of the regulating valve based on a monitored acoustic signal.

A further improvement of the present disclosure is that the fitting formula is obtained by calibrating the regulating valve through an experimental platform, which includes the following steps:

S101: installing the regulating valve and the acoustic sensor thereof onto a flow rate calibration experimental platform;

S102: debugging the regulating valve and various sensors thereof as well as a data collection system of the flow rate calibration experimental platform to remove noise interference;

S103: debugging pressure sensors at upstream and downstream of the regulating valve and a flow sensor of the flow rate calibration experimental platform to meet a calibration requirement;

S104: monitoring acoustic signals collected by the acoustic sensor of the regulating valve under different upstream pressures and different flow rates of the regulating valve; and

S105: correlating the flow rate of the regulating valve with the acoustic signal of the regulating valve under a condition of fixed upstream pressure of the regulating valve to obtain a fitting formula of the flow rate and acoustic signal of the regulating valve; and changing the upstream pressure of the regulating valve to obtain a plurality of fitting formulas.

A further improvement of the present disclosure is that the acoustic sensor is any one or a combination of N of a listening apparatus, a pickup, a micro-displacement electric signal sound sensor, a piezoelectric array sensor, a surface acoustic sensor, a dynamic pressure sensor, an acoustic frequency sensor, an acoustic sound pressure sensor, an acoustic sound intensity sensor and an acoustic sound power sensor, where N>1.

A further improvement of the present disclosure is that the surface acoustic sensor is any one or a combination of N of a Rayleigh wave sensor, an optical fiber sensor, a tangential horizontal plate-mold sensor, a Lamb wave sensor or a Love wave sensor, where N>1.

A further improvement of the present disclosure is that a listening apparatus or a pickup is arranged at a position of a shell of the regulating valve right opposite to a valve core thereof.

A further improvement of the present disclosure is that piezoelectric sensors in the piezoelectric array sensor are symmetrically arranged on a surface of a shell of the regulating valve and are arranged symmetrically with respect to the valve core of the regulating valve. Each piezoelectric array sensor consists of 2 to 5 piezoelectric sensors.

A further improvement of the present disclosure is that the optical fiber sensor is a combination of any one, two or three of a point-type optical fiber sensor, an integral optical fiber sensor and a distributed-type optical fiber sensor.

A further improvement of the present disclosure is that the flow sensor adopts an electromagnetic flow sensor, a volume flow sensor, a vortex flow sensor, a turbine flow sensor, an ultrasonic flow sensor or a differential pressure flow sensor.

A further improvement of the present disclosure is that the data analysis platform is loaded with a noise elimination algorithm.

A further improvement of the present disclosure is that the fitting formula is obtained by calibrating the regulating valve through the experimental platform, which includes the following steps:

S1: selecting the corresponding flow rate calibration pipeline and a model of the speed regulation variable-frequency circulating water pump based on a type and an aperture of the regulating valve;

S2: primarily estimating a flow rate range of the flow rate calibration pipeline based on the aperture of the pipeline and the speed regulation variable-frequency circulating water pump, and determining a model of the flow sensor;

S3: selecting a water storage tank of a corresponding volume, and replenishing water to the water storage tank;

S4: debugging an actuator of the regulating valve to allow the actuator to set and regulate the openness of the regulating valve;

S5: starting the speed regulation variable-frequency circulating water pump, setting the speed regulation variable-frequency circulating water pump as a rated rotating speed, and setting the openness of the regulating valve as 100%;

S6: carrying out data collection joint debugging for a flow rate calibration platform, in such a manner that the acoustic sensors, the flow sensor and the first pressure sensor operate normally;

S7: collecting the flow rate, the acoustic signal and the upstream pressure of the regulating valve under the openness of the regulating valve being 100% and the rated rotating speed of the speed regulation variable-frequency circulating water pump;

S8: changing the openness of the regulating valve, adjusting the upstream pressure of the regulating valve through the speed regulation variable-frequency circulating water pump, and monitoring the acoustic signal of the regulating valve and the flow rate of the regulating valve under different working conditions;

S9: correlating the flow rate of the regulating valve measured in S8 with the acoustic signal of the regulating valve under the corresponding working condition, drawing a relational characteristic curve of the acoustic signal and the flow rate value of the regulating valve, and fitting, according to the relational characteristic curve, a fitting formula for calculating the flow rate of the regulating valve based on the acoustic signal; and

S10: embedding the fitting formula fitted in S9 into the calibration platform, and rechecking whether flow rate data and the acoustic signal under a variable-flow working condition satisfy the fitting formula; if the rechecking is passed, measuring the flow rate of the regulating valve by using the fitting formula; and otherwise, repeating S1 to S10 until a result of the rechecking is that the flow rate and the acoustic signal of the regulating valve under the variable-flow working condition satisfy the fitting formula.

A further improvement of the present disclosure is that a horizontal axis and a longitudinal axis of the relational characteristic curve are the acoustic signal of the regulating valve and the flow rate of the regulating valve under different openness of the regulating valve, respectively; and the acoustic signal is an acoustic intensity, an acoustic pressure, an acoustic frequency or sound power.

Compared with the related art, the present disclosure has the following beneficial effects.

1) The flow rate of the regulating valve is monitored in real time through the relatively cheap acoustic sensor, so that no resistance and fault point may be brought to the fluid pipeline. The problem that the conventional flow measuring device is high in price and may bring additional resistance to the fluid system can be avoided.

2) According to the structural characteristics of the regulating valve, the acoustic sensor is directly added in the structure of the regulating valve to achieve the real-time and low-price online monitoring for these fluid devices.

3) For the regulating valve, the experimental platform is used to calibrate the relationship between the acoustic signal and the flow rate under conditions of determined upstream pressure and openness of the regulating valve, and the acoustic sensors can be used to achieve the low-price rough measurement of the flow rate of the regulating valve.

The experimental platform described in the present disclosure can be used to calibrate the flow rate for the acoustic sensors of different types and the regulating valve of different models and different types under different circulating flow rates and different upstream pressures of the regulating valve. After the experimental platform is used to calibrate the flow rate, the flow rate of the regulating valve can be measured through the relatively cheap acoustic sensors and the calibrated fitting formula within a given accuracy range. The flow sensor with a high price is no more used for flow rate detection, so that the flow rate detection cost is greatly reduced.

Furthermore, when the calibrated acoustic sensor is used to measure the flow rate of the regulating valve, the acoustic sensor may also receive the acoustic signal of the circulating water pump. When the circulating water pump has cavitation erosion or other faults, the acoustic signal may change. Therefore, the operation state of the circulating water pump installed on a same pipeline with the regulating valve can be determined based on the acoustic signal detected by the acoustic sensor.

Further, the data analysis platform has the noise elimination algorithm. The noise interference signal generated by the calibration pipeline, the actuator of the regulating valve, the circulating water pump and other fluid devices can be eliminated by monitoring a large amount of acoustic signal data of the experimental platform under the working conditions of different circulating flow rate and different openness of the regulating valve.

The method described in the present disclosure uses the above experimental platform to measure the flow rate and the acoustic signal of the regulating valve under the fixed upstream pressure and fixed openness so as to obtain the relational characteristic curve of the flow rate and the acoustic signal of the regulating valve and fits, according to the relational characteristic curve, the fitting formula for calculating the flow rate based on the acoustic signal. After checking that there is no error, the fitting formula is written into an acoustic detection system in a form of programs, and the acoustic sensors are installed on the regulating valve to be measured. The upstream pressure detection sensor is installed on the pipeline where the regulating valve is located. The output signal of the acoustic sensor is connected to the input end of the acoustic detection system, so that the flow rate of the regulating valve can be detected. In the subsequent flow rate detection, by only having the acoustic sensor installed on the regulating valve, the flow rate of the regulating valve can be measured or calculated based on the acoustic signal measured by the acoustic sensor, thereby greatly reducing the cost in detecting the flow rate of the regulating valve.

### BRIEF DESCRIPTION OF THE DRAWINGS

To more clearly describe the technical solutions in the embodiments of the present disclosure or in the related art, the drawings required to be used in the description of the embodiments or in the related art will be simply presented below. Apparently, the following drawings only show some embodiments of the present disclosure, so for those ordinary skilled in the art, other drawings can also be obtained according to the provided drawings without contributing creative labor.

FIG. 1 is a structural schematic diagram of a system for monitoring flow rate of a regulating valve based on an acoustic sensor according to the present disclosure;

FIG. 2 is a structural schematic diagram of a regulating valve according to embodiments of the present disclosure;

FIG. 3 is a schematic diagram of a fitting curve between the flow rate of the regulating valve and an acoustic signal of the regulating valve according to embodiments of the present disclosure;

FIG. 4 is a schematic diagram of an experimental platform provided by the present disclosure;

FIG. 5 is a schematic diagram of an embodiment 3 provided by the present disclosure;

FIG. 6a is a schematic diagram of a regulating valve with an acoustic sensor and having valve openness of 20%;

FIG. 6b is a schematic diagram of a regulating valve with an acoustic sensor and having valve openness of 50%;

FIG. 6c is a schematic diagram of a regulating valve with an acoustic sensor and having valve openness of 100%; and

FIG. 7 shows a relation curve between an acoustic intensity and openness of a regulating valve.

### LIST OF REFERENCE NUMERALS IN THE DRAWINGS

1 water storage tank

2 speed regulation variable-frequency circulating water pump

3 regulating valve

4 flow sensor

5 optical fiber

6 optical fiber sensor

7 pickup

9 flow rate calibration pipeline

10 water replenishing and drainage valve

11 first valve

12 second valve

13 third valve

14 fourth valve

15 acoustic sensor

16 first temperature sensor

17 first pressure sensor

18 second pressure sensor

19 second temperature sensor

21 flange

22 regulating valve core

23 regulating rod

24 actuator

30 piezoelectric array sensor

100 fluid pipeline

101 acoustic data analysis platform

### DESCRIPTION OF THE EMBODIMENTS

Technical solutions in embodiments of the present disclosure will be clearly and completely described in combination with accompanying drawings in embodiments of the present disclosure. Apparently, the described embodiments are merely some embodiments of the present disclosure, not all embodiments. Based on the embodiments of the present disclosure, all other embodiments obtained by those skilled in the art without creative effort fall within the protection scope of the present disclosure.

### Embodiment 1

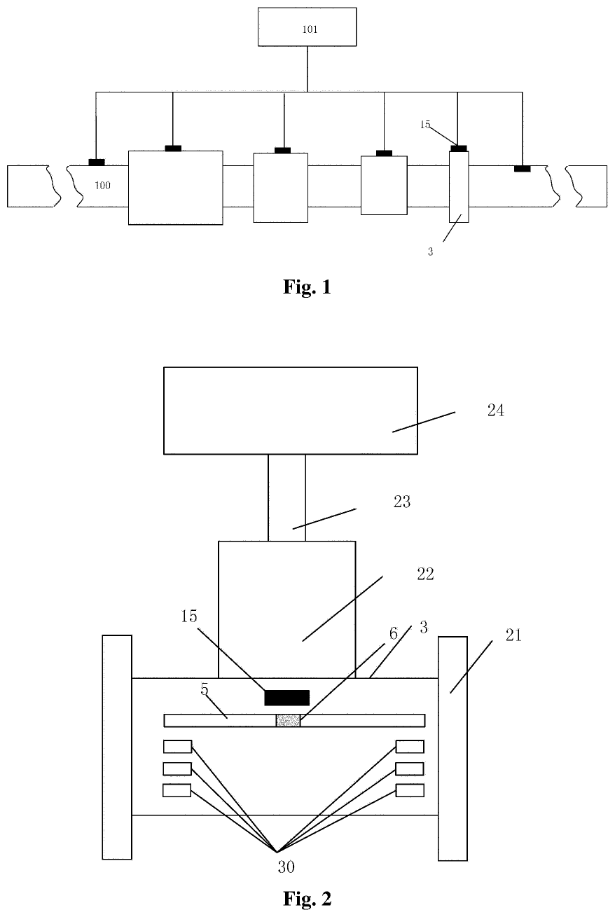

Referring to FIG. 1, the present disclosure provides a system for monitoring flow rate of a regulating valve based on an acoustic sensor, which includes regulating valves 3, acoustic sensors 15, a signal transmission apparatus and an acoustic data analysis platform 101.

The regulating valves 3 are installed in a fluid pipeline 100 at intervals. The regulating valves 3 are regulating valves calibrated by an experimental platform.

Each regulating valve is provided with at least one acoustic sensor. The acoustic sensor is arranged inside the regulating valve, or the acoustic sensor is outside the regulating valve and close to a valve core. Each acoustic sensor has an ID code corresponding to geographic information code of a geographic position of the acoustic sensor. The geographic information code and model information of the corresponding regulating valve are attached in the collected acoustic signals for being transmitted by the acoustic sensor.

The signal transmission apparatus is configured to receive the acoustic signals collected by the acoustic sensor and transmit the acoustic signals to the acoustic data analysis platform 101.

The acoustic data analysis platform 101 is arranged at a remote monitoring room and connected to the signal transmission apparatus in a wired or wireless way. The acoustic data analysis platform is configured to monitor the flow rate of the regulating valves by receiving the acoustic signals transmitted by the signal transmission apparatus. The acoustic data analysis platform further includes a display unit. The display unit is configured to display a position of each regulating valve and the corresponding acoustic signals in a form of a pipe network simulated picture.

In the present disclosure, the regulating valve may be a pneumatic regulating valve, an electric regulating valve or a hydraulic regulating valve. The regulating valve is one of a straightway single-seat valve, a straightway double-seat valve, a sleeve valve, a ball valve, a butterfly valve, an eccentric rotary valve, a linear valve, an equal-percentage valve, a parabolic valve and a quick opening valve.

Referring to FIG. 2, the regulating valve 3 is installed in the fluid pipeline 100 through flanges 21 at two sides thereof. The acoustic sensor 15 is arranged outside the regulating valve and is close to the valve core. The regulating valve includes a regulating valve core 22 (a valve body), a regulating rod 23 and an actuator 24. The actuator 24 is connected to the regulating valve core 22 through the regulating rod 23. The actuator 24 is connected to a remote controller through a signal transmission apparatus, and is configured to receive an instruction from the remote controller, in such a manner that the openness of the regulating valve core 22 can be operated by the actuator 24.

In the present disclosure, the acoustic sensor may be a listening apparatus, a pickup, a micro-displacement electric signal sound sensor, a surface acoustic sensor, a dynamic pressure sensor, an acoustic frequency sensor, an acoustic sound pressure sensor, an acoustic sound intensity sensor or an acoustic sound power sensor.

In the present disclosure, the surface acoustic sensor may be a Rayleigh wave sensor, an optical fiber sensor 6, a piezoelectric array sensor 30, a tangential horizontal plate-mold sensor, a Lamb wave sensor or a Love wave sensor.

### Embodiment 2

The present disclosure further provides a method for acoustically monitoring flow rate of a regulating valve, which is used to monitor the flow rate of the regulating valve and specifically includes the following steps.

At S101, the regulating valves and acoustic sensors thereof are installed onto a flow rate calibration experimental platform.

At S102, the regulating valves and various sensors thereof as well as a data collection system of the flow rate calibration experimental platform are debugged to achieve the acoustic signal collection by the qualified acoustic sensors without the noise interference and meet the calibration requirement.

At S103, pressure sensors at upstream and downstream of the regulating valves and a flow sensor of the calibration experimental platform are debugged to meet the calibration requirement.

At S104, under different upstream pressures and different flow rates of the regulating valves, the acoustic signals collected by the acoustic sensors of the regulating valves are monitored. The acoustic signal includes an acoustic frequency, an acoustic intensity, an acoustic pressure and an acoustic power.

At S105, the above data is subjected to a correlation analysis: under a condition of a fixed regulating valve upstream pressure, the flow rate of the regulating valve is correlated with the acoustic signal of the regulating valve to obtain a fitting formula; and multiple fitting formulas can be obtained by changing the regulating valve upstream pressure. Referring to FIG. 3, when the acoustic intensity is A, the flow rate of the regulating valve is 10 m³/s; when the acoustic intensity is B, the flow rate of the regulating valve is 25 m³/s; and when the acoustic intensity is C, the flow rate of the regulating valve is 55 m³/s. The more points may result in that the final fitting curve is more accurate.

At S106, another regulating valve of the same model is used to carry out the checkout experiment for the obtained fitting formula under the same experimental calibration condition.

At S107, in the practical detection process, the corresponding fitting formula is determined based on the upstream pressure of the regulating valve of the monitored model to calculate the flow rate of the corresponding regulating valve based on the monitored acoustic signal.

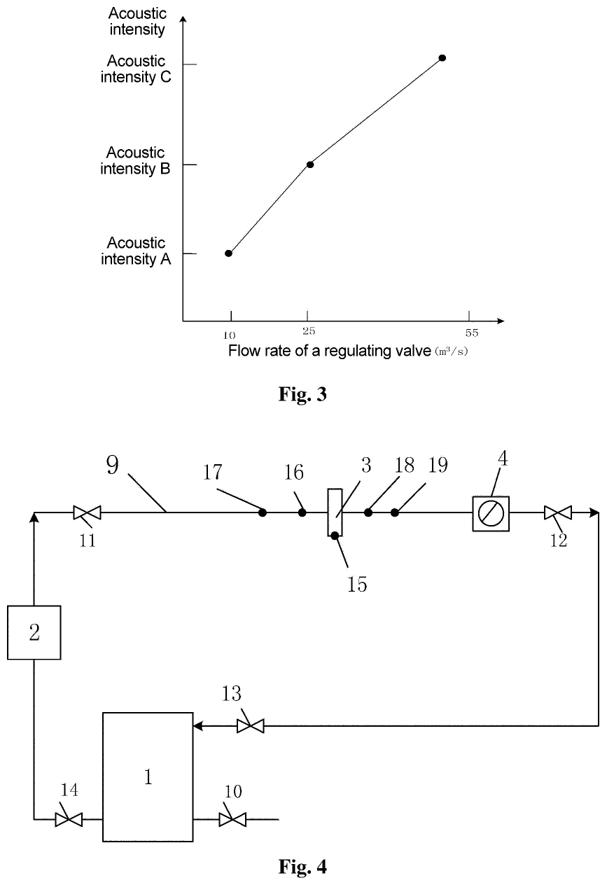

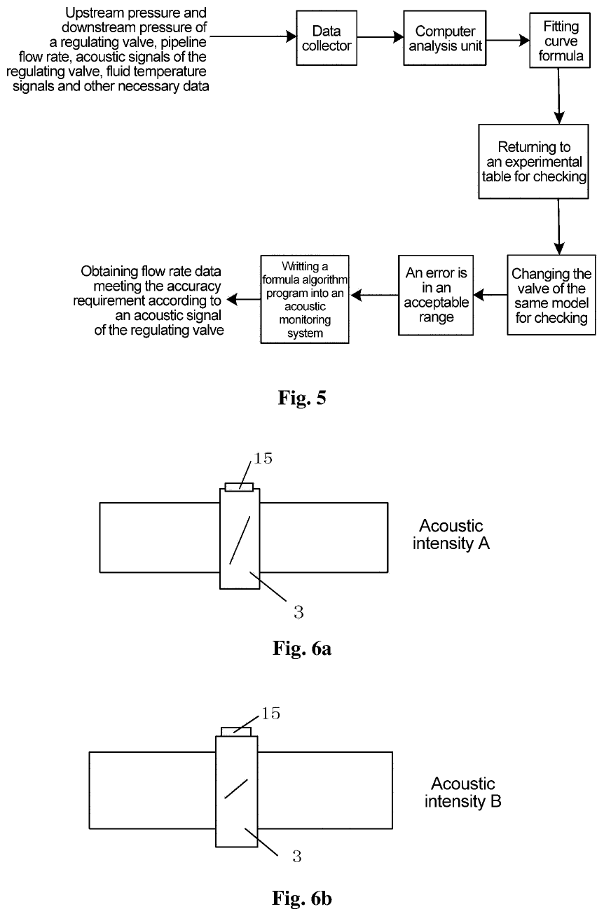

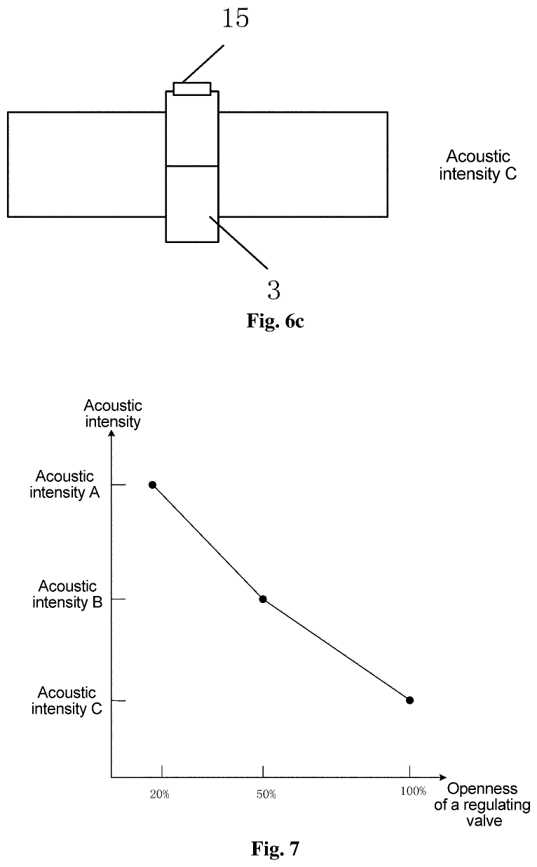

Referring to FIG. 4, the experimental platform used in the present disclosure is used to carry out the experimental calibration for the regulating valves 3 in embodiment 1 or 2. The experimental platform includes a flow rate calibration pipeline 9 and a water storage tank 1. An inlet of the flow rate calibration pipeline 9 is connected to an outlet of the water storage tank 1, and an outlet of the flow rate calibration pipeline 9 is connected to an inlet of the water storage tank 1. The flow rate calibration pipeline 9 is provided with a speed regulation variable-frequency circulating water pump 2 and a regulating valve 3 and an actuator 24 thereof (electric, pneumatic or hydraulic actuator). A fourth valve 14 is installed between the water storage tank 1 and the speed regulation variable-frequency circulating water pump 2. The pipeline between the speed regulation variable-frequency circulating water pump 2 and the regulating valve 3 is successively provided with a first valve 11, a first temperature sensor 17 and a first pressure sensor 16. A pipeline between the regulating valve 3 and the water storage tank 1 is successively provided with a second pressure sensor 18, a second temperature sensor 19, a flow sensor 4, a second valve 12 and a third valve 13. A water replenishing pipeline of the water storage tank 1 is provided with a water replenishing valve 10. An acoustic sensor 15 is installed on the regulating valve 3.

Output ends of the first temperature sensor 17, the first pressure sensor 16, the second pressure sensor 18, the second temperature sensor 19, the flow sensor 4 and the acoustic sensor 15 are connected to an input end of a data collector, and an output end of the data collector is connected to the input end of the data analysis platform.

The acoustic sensor 15 is configured to collect the acoustic signal of the regulating valve 3. The flow sensor 4 is configured to measure the flow rate of the regulating valve. The first pressure sensor 16 is configured to measure an upstream pressure of the regulating valve. The first temperature sensor 17 is configured to measure an upstream temperature of the regulating valve. The second pressure sensor 18 is configured to measure a downstream pressure of the regulating valve. The second temperature sensor 19 is configured to measure a downstream temperature of the regulating valve.

The data collector transmits signals collected by the acoustic sensor 15, the flow sensor 4, the first pressure sensor 16, the first temperature sensor 17, the second pressure sensor 18 and the second temperature sensor 19 to the data analysis platform. The data analysis platform uses a computer to perform an analysis and fitting to obtain a data formula of the acoustic signal relative to the flow rate under different openness of the regulating valve, and the data formula is written into a calculation program to be used as a flow rate calculation formula for such regulating valve and applied in a flow rate monitoring system of the regulating valve of the same model.

The acoustic sensor may be any one or a combination of a listening-apparatus acoustic sensor, a pickup-type acoustic sensor, a micro-displacement electric signal sound sensor, a piezoelectric array sensor, a surface acoustic sensor, a dynamic pressure sensor, an acoustic frequency sensor, an acoustic sound pressure sensor, an acoustic sound intensity sensor (the sound intensity sensor can measure the ambient sound intensity and adopts an electret microphone to collect a sound signal, and after the sound signal is magnified by a circuit, the sound intensity value can be outputted) and an acoustic sound power sensor. The combination may be a combination of the acoustic frequency sensor and the acoustic sound pressure sensor, a combination of the acoustic sound pressure sensor and the acoustic sound intensity sensor, a combination of the listening apparatus-type acoustic sensor and the acoustic sound intensity sensor, or a combination of the pickup-type acoustic sensor and the acoustic sound pressure sensor. When the combination of two or more acoustic sensors is used, one acoustic sensor is used for calibration, and the acoustic signal received by another sensor is used for reference.

Referring to FIG. 2, the listening apparatus-type or pickup-type acoustic sensor is arranged on an outer surface of the valve on a central axis corresponding to a valve core of the regulating valve 3, or arranged in a valve shell on the central axis corresponding to the valve core in a perforating manner.

The piezoelectric array sensors 30 are symmetrically arranged on the surface of the valve shell at two sides of the valve core of the regulating valve 3. Each piezoelectric array sensor 30 consists of 2 to 5 piezoelectric sensors.

The surface acoustic sensor may be any one or a combination of a Rayleigh wave sensor, an optical fiber sensor, a tangential horizontal plate-mold sensor, a Lamb wave sensor or a Love wave sensor.

The optical fiber sensor may be any one or a combination of a point-type optical fiber sensor, an integral optical fiber sensor and a distributed-type optical fiber sensor.

The pipeline flow sensor adopts any one of an electromagnetic flow sensor, a volume flow sensor, a vortex flow sensor, a turbine flow sensor, an ultrasonic flow sensor and a differential pressure flow sensor.

The data analysis platform has a noise elimination algorithm and eliminates noise interference signals generated by the calibration pipeline, the regulating valve actuator, the circulating water pump and other fluid devices by monitoring a great amount of acoustic signals of the experimental platform under the working conditions of different circulating flow rates and different openness of the regulating valve.

The noise elimination algorithm may be one or a combination of more of a filter algorithm, a wavelet analysis method, a mean and approximate value removal method and a discrete Fourier transform quick algorithm. The noise elimination algorithm or the combination of the above noise elimination algorithms is selected based on the type of the noise to denoise the acoustic signal.

### Embodiment 3

The present embodiment also provides a more specific method for acoustically monitoring flow rate of a regulating valve, which is used to monitor the flow rate of the regulating valve and specifically includes the following steps.

At S1, a pipeline aperture of a corresponding flow rate calibration pipeline 9 is selected based on the type and the aperture of the regulating valve 3 and matched with the model of the corresponding speed regulation variable-frequency circulating water pump 2, and a speed regulation variable-frequency range of the corresponding circulating water pump 2 is selected.

At S2, the type and the model of the corresponding flow sensor 4 are selected based on the flow rate range of the flow rate calibration pipeline 9 primarily estimated by the aperture of the speed regulation variable-frequency circulating water pump 2 and the pipeline.

At S3, a water storage tank 1 of the corresponding volume is provided, and water is replenished to the water storage tank 1 through a water replenishing pipeline.

At S4, an actuator of the regulating valve 3 is debugged, and when the calibration experimental platform gives certain openness of the regulating valve, the actuator can rapidly complete the setting and action of the openness of the regulating valve.

At S5, the speed regulation variable-frequency circulating water pump 2 is started and set at a rated rotating speed, and the openness of the regulating valve 3 is set as 100%.

At S6, the data collector, the computer data analysis platform and the entire flow experimental platform are subjected to the data collection joint debugging, so that the acoustic sensor 15, the flow sensor 4, the first pressure sensor 16, the first temperature sensor 17, the second pressure sensor 18 and the second temperature sensor 19 can complete the data collection work normally. The first pressure sensor 16 is configured to measure the upstream pressure, the first temperature sensor 17 is configured to measure the upstream temperature, the second pressure sensor 18 is configured to measure the downstream pressure, and the second temperature sensor 19 is configured to measure the downstream temperature.

At S7, the data collector collects the flow rate, the acoustic signal, the upstream pressure, the downstream pressure, the upstream temperature and the downstream temperature of the regulating valve under the full openness of the regulating valve 3 and the rated rotating speed of the speed regulation variable-frequency circulating water pump 2; and the upstream temperature and the downstream temperature are used to determine whether the temperature affects the flow rate, and the upstream pressure is used to guarantee the objective conditions of the experimental platform.

At S8, according to a variable-working-condition calibration data table, the openness of the regulating valve is changed, a variable-flow regulation working condition of the upstream pressure is indirectly changed by the speed regulation variable-frequency circulating water pump 2, and the acoustic signal of the corresponding regulating valve 3 is collected by the data collector and transmitted to a computer data analysis platform. The variable-working-condition calibration data is used to measure the acoustic signal and the flow rate of the regulating valve 3 under different openness of the regulating valve under the set upstream pressure.

At S9, the computer data analysis platform correlates the flow rate of the regulating valve 3 measured by the flow sensor 4 under the variable working condition with the acoustic signal of the regulating valve 3 of the corresponding working condition and draws multiple relational characteristic curves between the acoustic signal of the regulating valve 3 and the flow rate value of the regulating valve 3. The upstream pressure and the openness corresponding to each relational characteristic curve are fixed. A fitting formula for calculating the flow rate based on the acoustic signal is fitted according to the relational characteristic curve. A horizontal axis of the relational characteristic curve is the acoustic signal of the regulating valve under different flow working conditions and a longitudinal axis is the flow rate signal data under different openness of the regulating valve; or the horizontal axis is the flow rate signal data under different openness of the regulating valve, and the longitudinal axis is the acoustic signal of the regulating valve under different flow working conditions. The acoustic signal may be a sound pressure, an acoustic intensity, an acoustic frequency or sound power. The corresponding curve of the acoustic intensity and the openness of the regulating valve is shown in FIG. 7.

At S10, the formula fitted in S9 is embedded into the experimental platform, and whether the flow rate data and the acoustic signal under the variable flow working condition satisfy the fitting formula is rechecked: the regulating valve of the same model is used to replace the regulating valve used in S1 to S9, the steps S7 to S8 are repeated, and the measured flow rate is compared with the flow rate obtained in the fitting formula to see whether the measured flow rate is in an error range. If the error is in the acceptable range, it means that the fitting formula can be used for the flow rate detection, and the fitting formula is written into an acoustic detection system. If the error is not in the acceptable range, the steps S1 to S10 are repeated until the rechecking result is that the flow rate data and the acoustic signal under the variable flow working condition satisfy the fitting formula.

At Sit in the practical detection process, the corresponding fitting formula is found based on the upstream pressure of the regulating valve of the monitored model to calculate the flow rate of the corresponding regulating valve based on the monitored acoustic signal.

After the fitting formula is obtained by the experimental platform, the fitting formula is written into the acoustic detection system in a form of programs, and an acoustic sensor is installed on a regulating valve to be measured. A detection sensor is installed at an upstream of the regulating valve in the pipeline where the regulating valve is located. An output signal of the acoustic sensor is connected to the input end of the acoustic detection system. The acoustic detection system detects the flow rate of the regulating valve based on the collected acoustic signal, the upstream pressure, the openness of the regulating valve according to the fitting formula.

### Embodiment 4

The present embodiment differs from the steps of embodiment 3 in that in S8, according to the variable-working-condition calibration data table, the openness of the regulating valve is changed, the variable-flow regulation working condition of the upstream pressure is indirectly changed by the speed regulation variable-frequency circulating water pump 2, and the acoustic signal of the corresponding regulating valve 3 is collected by the data collector and transmitted to the computer data analysis platform; and the variable-working-condition calibration data is used to measure the acoustic signal and the flow rate of the regulating valve 3 under different openness of the regulating valve under the set upstream pressure. For example, under the condition that the upstream pressure is increased to 10 Bar from 0.1 Bar at a step length of 0.1 Bar, the flow rate of the regulating valve with the openness of 10%, 20%, 30%, 40%, 50%, 60%, 70%, 80%, 90% and 100% is shown in table 1.

TABLE 1

| | Set value | | Measurement result | |
|---|---|---|---|---|
| | | Openness | | Flow rate |
| | | of | | of |
| | Upstream | regulating | Acoustic | regulating |
| No. | pressure | valve | signal | valve |
| 1. | 0.1Bar | 10% | | |
| 2. | | 20% | | |
| 3. | | 30% | | |
| 4. | | 40% | | |
| 5. | | 50% | | |
| 6. | | 60% | | |
| 7. | | 70% | | |
| 8. | | 80% | | |
| 9. | | 90% | | |
| 10. | | 100% | | |
| 11. | 0.2Bar | 10% | | |
| 12. | | 20% | | |
| 13. | | 30% | | |
| 14. | | 40% | | |
| 15. | | 50% | | |
| 16. | | 60% | | |
| 17. | | 70% | | |
| 18. | | 80% | | |
| 19. | | 90% | | |
| 20. | | 100% | | |
| 21. | 0.3Bar | 10% | | |
| 22. | | 20% | | |
| 23. | | 30% | | |
| 24. | | 40% | | |
| 25. | | 50% | | |
| 26. | | 60% | | |
| 27. | | 70% | | |
| 28. | | 80% | | |
| 29. | | 90% | | |
| 30. | | 100% | | |
| 31. | . . . | . . . | | |
| 32. | 10Bar | 10% | | |
| 33. | | 20% | | |
| 34. | | 30% | | |
| 35. | | 40% | | |
| 36. | | 50% | | |
| 37. | | 60% | | |
| 38. | | 70% | | |
| 39. | | 80% | | |
| 40. | | 90% | | |
| 41. | | 100% | | |

Table 1 shows only an example and it is also possible to show the flow rate of the regulating valve with the openness of 10%, 20%, 30%, 40%, 50%, 60%, 70%, 80%, 90% and 100% under the condition that the upstream pressure is increased to 10 Bar from 0.5 Bar at a step length of 0.5 Bar, or the flow rate of the regulating valve with the openness of 5%, 10%, 5%, 15%, 20%, 25%, 30%, 5%, 40%, 45%, 50%, 55%, 60%, 65%, 70%, 75%, 80%, 85%, 90%, 95% and 100% under the condition that the upstream pressure is increased to 10 Bar from 0.5 Bar at a step length of 0.5 Bar.

Various embodiments of the present disclosure are described in a progressive manner. Each embodiment focuses on the difference from other embodiments, while same or similar parts of all embodiments can be referred to each other.

A pipeline fluid transport system and method with acoustic monitoring provided in the present disclosure are stated above in detail. The principle and embodiments of the present disclosure are described herein with a specific example. The above embodiments are explained to help the understanding of the method and core concept of the present disclosure. It should be pointed out that various improvements and modifications may be made by those skilled in the art without departing from the concept of the present disclosure. These improvements and modifications should also be regarded as the protection scope of the present disclosure.

What is claimed is:

1. A system for monitoring flow rate of a regulating valve based on an acoustic sensor, comprising:
the regulating valve installed in a fluid pipeline, the regulating valve comprising an actuator and a valve body and being a regulating valve calibrated by an experimental platform;
the acoustic sensor installed at the regulating valve and configured to collect an acoustic signal of the regulating valve and transmit the acoustic signal to a signal transmission apparatus;
the signal transmission apparatus configured to receive the acoustic signal collected by the acoustic sensor and transmit the acoustic signal to an acoustic data analysis platform; and
the acoustic data analysis platform configured to monitor flow rate of the regulating valve by receiving the acoustic signal transmitted by the signal transmission apparatus.

2. The system according to claim 1, wherein the regulating valve is a pneumatic regulating valve, an electric regulating valve or a hydraulic regulating valve.

3. The system according to claim 1, wherein the regulating valve is one of a straightway single-seat valve, a straightway double-seat valve, a sleeve valve, a ball valve, a butterfly valve, an eccentric rotary valve, a linear valve, an equal-percentage valve, a parabolic valve, or a quick opening valve.

4. The system according to claim 1, wherein the acoustic sensor is any one or a combination of a listening apparatus, a pickup, a micro-displacement electric signal sound sensor, a surface acoustic sensor, a dynamic pressure sensor, an acoustic frequency sensor, an acoustic sound pressure sensor, an acoustic sound intensity sensor or an acoustic sound power sensor.

5. The system according to claim 4, wherein the surface acoustic sensor is any one or a combination of a Rayleigh wave sensor, an optical fiber sensor, a piezoelectric array sensor, a tangential horizontal plate-mold sensor, a Lamb wave sensor or a Love wave sensor.

6. The system according to claim 1, wherein the acoustic sensor is arranged inside the regulating valve, or is arranged outside the regulating valve and close to a valve core thereof.

7. The system according to claim 1, wherein the acoustic sensor has an ID code corresponding to a geographic information code of a geographic position of the acoustic sensor; and the geographic information code and model information of the regulating valve are attached in the collected acoustic signal for being transmitted by the acoustic sensor.

8. The system according to claim 6, wherein the acoustic data analysis platform further comprises a display unit configured to display a position of the regulating valve and the corresponding acoustic signal.

9. The system according to claim 1, wherein the acoustic data analysis platform performs an analysis to obtain the flow rate of the regulating valve by:
calculating the flow rate of the regulating valve under a condition of a given upstream pressure by using a pre-fitted relational formula between the acoustic signal and the flow rate of the regulating valve of a model to be analyzed under an adjustment of the given upstream pressure.

10. The system according to claim 1, wherein the data analysis platform is loaded with a noise elimination algorithm.

11. The system according to claim 1, wherein the experimental platform comprises a flow rate calibration pipeline; an inlet of the flow rate calibration pipeline is connected to an outlet of a water storage tank, and an outlet of the flow rate calibration pipeline is connected to an inlet of the water storage tank; a speed regulation variable-frequency circulating water pump and the regulating valve are installed in the flow rate calibration pipeline; a first pressure sensor is installed at an upstream of the regulating valve in the flow rate calibration pipeline, and a flow sensor is installed at a downstream of the regulating valve in the flow rate calibration pipeline; and the acoustic sensor is provided on the regulating valve;
output ends of the flow sensor, the first pressure sensor and the acoustic sensor are connected to an input end of a data collector, and an output end of the data collector is connected to an input end of the acoustic data analysis platform;
the data collector is configured to transmit acoustic signals, flow signals and upstream pressure signals collected by the acoustic sensor, the flow sensor and the first pressure sensor to the data analysis platform; and the data analysis platform is configured to fit a relational expression between the acoustic signal and the flow rate of the regulating valve under different upstream pressures and openness of the regulating valve based on the received acoustic signals, the flow signals and the upstream pressure signals.

12. A method for monitoring flow rate of a regulating valve based on an acoustic sensor, comprising the following steps based on the system for monitoring the flow rate of the regulating valve based on the acoustic sensor of claim 1:
obtaining a corresponding fitting formula based on an upstream pressure of the regulating valve of a monitored model in a practical detection process, and calculating the flow rate of the regulating valve based on a monitored acoustic signal.

13. The method according to claim 12, wherein the fitting formula is obtained by calibrating the regulating valve through an experimental platform, which comprises the following steps:
S101: installing the regulating valve and the acoustic sensor thereof onto a flow rate calibration experimental platform;
S102: debugging the regulating valve and various sensors thereof as well as a data collection system of the flow rate calibration experimental platform to remove noise interference;
S103: debugging pressure sensors at upstream and downstream of the regulating valve and a flow sensor of the flow rate calibration experimental platform to meet a calibration requirement;
S104: monitoring acoustic signals collected by the acoustic sensor of the regulating valve under different upstream pressures and different flow rates of the regulating valve; and
S105: correlating the flow rate of the regulating valve with the acoustic signal of the regulating valve under a condition of fixed upstream pressure of the regulating valve to obtain a fitting formula of the flow rate and the acoustic signal of the regulating valve; and changing the upstream pressure of the regulating valve to obtain a plurality of fitting formulas.

14. The method according to claim 12, wherein the fitting formula is obtained by calibrating the regulating valve through the experimental platform, which comprises the following steps:
S1: selecting the corresponding flow rate calibration pipeline and a model of the speed regulation variable-frequency circulating water pump based on a type and an aperture of the regulating valve;
S2: primarily estimating a flow rate range of the flow rate calibration pipeline based on the aperture of the pipeline and the speed regulation variable-frequency circulating water pump, and determining a model of the flow sensor;
S3: selecting a water storage tank of a corresponding volume, and replenishing water to the water storage tank;
S4: debugging an actuator of the regulating valve to allow the actuator to set and regulate the openness of the regulating valve;
S5: starting the speed regulation variable-frequency circulating water pump, setting the speed regulation variable-frequency circulating water pump as a rated rotating speed, and setting the openness of the regulating valve as 100%;
S6: carrying out data collection joint debugging for a flow rate calibration platform, in such a manner that the acoustic sensors, the flow sensor and the first pressure sensor operate normally;
S7: collecting the flow rate, the acoustic signal and the upstream pressure of the regulating valve under the openness of the regulating valve being 100% and the rated rotating speed of the speed regulation variable-frequency circulating water pump;
S8: changing the openness of the regulating valve, adjusting the upstream pressure of the regulating valve through the speed regulation variable-frequency circulating water pump, and monitoring the acoustic signal of the regulating valve and the flow rate of the regulating valve under different working conditions;
S9: correlating the flow rate of the regulating valve measured in S8 with the acoustic signal of the regulating valve under the corresponding working condition, drawing a relational characteristic curve of the acoustic signal and the flow rate value of the regulating valve, and fitting, according to the relational characteristic curve, a fitting formula for calculating the flow rate of the regulating valve based on the acoustic signal; and
S10: embedding the fitting formula fitted in S9 into the calibration platform, and rechecking whether flow rate data and the acoustic signal under a variable-flow working condition satisfy the fitting formula; if the rechecking is passed, measuring the flow rate of the regulating valve by using the fitting formula; and otherwise, repeating S1 to S10 until a result of the rechecking is that the flow rate and the acoustic signal of the regulating valve under the variable-flow working condition satisfy the fitting formula.

15. The method according to claim 14, wherein a horizontal axis and a longitudinal axis of the relational characteristic curve are the acoustic signal of the regulating valve and the flow rate of the regulating valve under different openness of the regulating valve, respectively; and the acoustic signal is an acoustic intensity, an acoustic pressure, an acoustic frequency or sound power.
